(19) United States
(12) Patent Application Publication
(10) Pub. No.: US 2015/0098726 A1
(43) Pub. Date: Apr. 9, 2015

(54) CLEANING DEVICE AND IMAGE FORMING APPARATUS INCLUDING SAME

(71) Applicant: KYOCERA DOCUMENT SOLUTIONS INC., Osaka (JP)

(72) Inventors: Kiyotaka KOBAYASHI, Osaka (JP); Shingo SAKATO, Osaka (JP); Takuji WATANABE, Osaka (JP)

(73) Assignee: KYOCERA DOCUMENT SOLUTIONS INC., Osaka (JP)

(21) Appl. No.: 14/480,081

(22) Filed: Sep. 8, 2014

(30) Foreign Application Priority Data
Oct. 9, 2013 (JP) 2013-211873

(51) Int. Cl. G03G 21/00

(52) U.S. Cl. CPC G03G 21/0011; G03G 21/0035; G03G 21/105; G03G 2221/001
USPC 399/102; 399/349

(57) ABSTRACT

A cleaning device includes a housing, a cleaning member, a cleaning blade, a collection member, a seal member, and a protection member. The housing is disposed above an image carrier, and an opening is formed in a face thereof facing the image carrier. The cleaning member rotates contacting a surface of the image carrier and the image carrier contact each other, and thereby, residual toner adhered to the image carrier is removed downstream of the image carrier in the rotation direction of the image carrier. The seal member is disposed at an upstream-side edge of the opening of the housing with respect to the rotation direction of the image carrier, and the seal member prevents leakage of waste toner through a gap between the housing and the image carrier. The protection member is disposed above the seal member with an interval therebetween, and the protection member contacts the cleaning member.

### INCORPORATION BY REFERENCE

This application is based upon and claims the benefit of priority from the corresponding Japanese Patent Application No. 2013-211873, filed on Oct. 9, 2013, the entire contents of which are incorporated herein by reference.

### BACKGROUND OF THE INVENTION

The present disclosure relates to a cleaning device equipped with a mechanism that uses a cleaning member to remove residual toner remaining on a surface of an image carrier, and in particular, relates to a method for preventing leakage of toner from a cleaning device.

In image forming apparatuses using an electrophotographic method, such as a copier, a printer, and a facsimile, a developer in a powder form is mainly used, and the following process is typically performed; that is, an electrostatic latent image formed on an image carrier such as a photosensitive drum is visualized by using a developing device, and the thus visualized image (a toner image) is transferred onto a recording medium, which then undergoes fixing processing. Then, after toner remaining on a surface of the image carrier is removed by a cleaning device, formation of a new toner image is performed.

A typical cleaning device includes: a cleaning member, such as a fur brush and a cleaning roller, which removes toner from a surface of an image carrier; and a conveyance spiral that discharges waste toner scraped off by the cleaning member to outside, the cleaning member and the conveyance spiral being disposed inside a housing.

In what is called a vertical conveyance type image forming apparatus, where a recording medium is conveyed upward from a lower portion of a body of the image forming apparatus, a cleaning device is disposed above an image carrier. With this arrangement, there is a possibility that waste toner removed by a cleaning member may fall through a gap between a housing of the cleaning device and the image carrier.

To prevent this, in some of such image forming apparatuses as described above, a seal member formed of a resin film or the like is attached to an opening portion of the housing of the cleaning device. By closing the gap between the housing and the image carrier with the seal member, leakage of waste toner inside the housing to outside the cleaning device is prevented.

Further, there has been known a cleaning device including a protection member that is disposed above the seal member so as to cover the seal member to prevent accumulation of toner on the seal member.

### SUMMARY OF THE INVENTION

According to one aspect of the present disclosure, a cleaning device includes a housing, a cleaning member, a cleaning blade, a collection member, a seal member, and a protection member. The housing is disposed above a cylindrical image carrier on an outer circumferential surface of which a toner image is carried, and the housing has an opening formed in a face thereof facing the image carrier. The cleaning member is disposed in the vicinity of the opening of the housing, and the cleaning member removes residual toner adhered to the image carrier downstream of the image carrier in the rotation direction of the image carrier by rotating in contact with a surface of the image carrier in a direction same as a rotation direction of the image carrier as seen at a contact surface where the cleaning member and the image carrier contact each other. The cleaning blade contacts the outer circumferential surface of the image carrier at a position downstream of the cleaning member with respect to the rotation direction of the image carrier, and the cleaning blade removes the residual toner remaining on the image carrier. The collection member collects waste toner inside the housing, and conveys the collected waste toner to outside the housing. The seal member is disposed at an upstream-side edge of the opening of the housing with respect to the rotation direction of the image carrier, and the seal member prevents leakage of the waste toner through the gap between the housing and the image carrier by contacting the outer circumferential surface of the image carrier at a position upstream of the cleaning member with respect to the rotation direction of the image carrier. The protection member is disposed above the seal member with an interval therebetween, and the protection member contacts the cleaning member.

Still other objects and specific advantages of the present disclosure will become apparent from the following descriptions of preferred embodiments.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a side sectional view showing an overall structure of an image forming apparatus 100 including a cleaning device 18 of the present disclosure;

FIG. 2 is a side sectional view showing a charging device 4, a photosensitive drum 5, and a cleaning device 18 according to a first embodiment of the present disclosure;

FIG. 3 is a partial enlarged view showing a cleaning brush 30 of the cleaning device 18 shown in FIG. 2 and an area around the cleaning brush 30;

FIG. 4 is a side sectional view showing the charging device 4, the photosensitive drum 5, and a cleaning device 18 according to a second embodiment of the present disclosure; and

FIG. 5 is a partial enlarged view showing a rubbing roller 50 of the cleaning device 18 shown in FIG. 4 and an area around the rubbing roller 50.

### DETAILED DESCRIPTION OF THE EMBODIMENTS

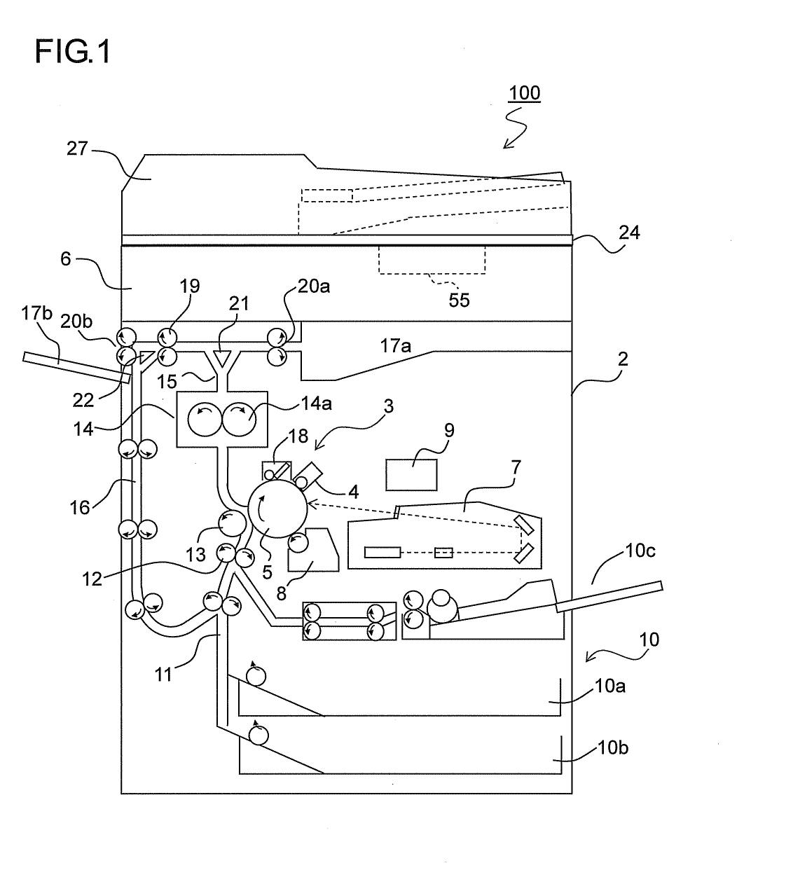

Hereinafter, embodiments of the present disclosure will be described with reference to the accompanying drawings. FIG. 1 is a diagram schematically showing a structure of an image forming apparatus 100 including a cleaning device 18 of the present disclosure. In FIG. 1, in the image forming apparatus 100 (here, a digital multifunction peripheral (MFP) is shown as an example), in performing a copying operation, image data of a document is read and converted into an image signal at an image reading portion 6, which will be described later. On the other hand, in an image forming portion 3 inside a body 2 of the MFP, a photosensitive drum 5, which rotates in a direction A shown in the figure, is uniformly charged by a charging device 4. Then, a laser beam based on the image data of the document read at the image reading portion 6 comes from an exposure device (such as a laser scanning unit) 7 to form, on the photosensitive drum 5, an electrostatic latent image, to which a developer (henceforth, a toner) is caused to adhere by a developing device 8, and thereby a toner image is formed. The developing device 8 receives supply of toner from a toner container 9.

A sheet is conveyed toward the photosensitive drum 5 on which the toner image is formed in the above-described manner. That is, a sheet is conveyed from a sheet feeding mechanism 10 via a sheet conveyance path 11 and a regist roller pair 12 to the image forming portion 3. Then, at the image forming portion 3, the toner image on a surface of the photosensitive drum 5 is transferred onto the sheet by a transfer roller 13 (an image transfer portion). The sheet onto which the toner image has been transferred is separated from the photosensitive drum 5 and conveyed to a fixing portion 14 that includes a fixing roller pair 14a, where the toner image is fixed on the sheet. The sheet that has passed through the fixing portion 14 is sent to a sheet conveyance path 15 that is branched in a plurality of directions. At branching points of the sheet conveyance path 15, path switching mechanisms 21 and 22 including a plurality of path switch guides are provided. Sheet conveyance directions are sorted by the path switching mechanisms 21 and 22, and the sheet is discharged to a sheet discharge portion constituted with a first discharge tray 17a and a second discharge tray 17b directly as it is (or after being sent to a reverse sheet conveyance path 16 for two-sided copying).

Furthermore, although not illustrated, a charge-removing device for removing residual charges remaining on the surface of the photosensitive drum 5 is disposed downstream of a cleaning device 18. Moreover, the sheet feeding mechanism 10 includes a plurality of sheet feeding cassettes 10a and 10b which are detachably attached in the body 2 of the MFP, and in which sheets are stored and a stack bypass (a manual sheet feeding tray) 10c disposed above the plurality of sheet feeding cassettes 10a and 10b. The sheet feeding cassettes 10a and 10b and the stack bypass 10c of the sheet feeding mechanism 10 are connected to the image forming portion 3 constituted with the photosensitive drum 5, the developing device 8, etc., via the sheet conveyance path 11.

In the MFP, the image reading portion 6 is disposed in an upper portion of the body 2, and a platen (a document holder) 24 that presses and holds a document placed on a contact glass 25 (see FIG. 3) of the image reading portion 6 is provided in an openable and closable manner on an upper surface of the body 2. A document conveying device 27 is provided on the platen 24.

The sheet conveyance path 15 is first branched into two, right and left paths at a position downstream of the fixing roller pair 14a, specifically, and one path of the two paths (which is branched in the right direction in FIG. 1) leads to the first discharge tray 17a. The other path (which is branched in the left direction in FIG. 1) is further branched into two paths via a conveyance roller pair 19, and one of the two paths (which is branched in the left direction in FIG. 1) leads to the second discharge tray 17b. In contrast, the other path (which is branched in a downward direction in FIG. 1) leads to the reverse sheet conveyance path 16.

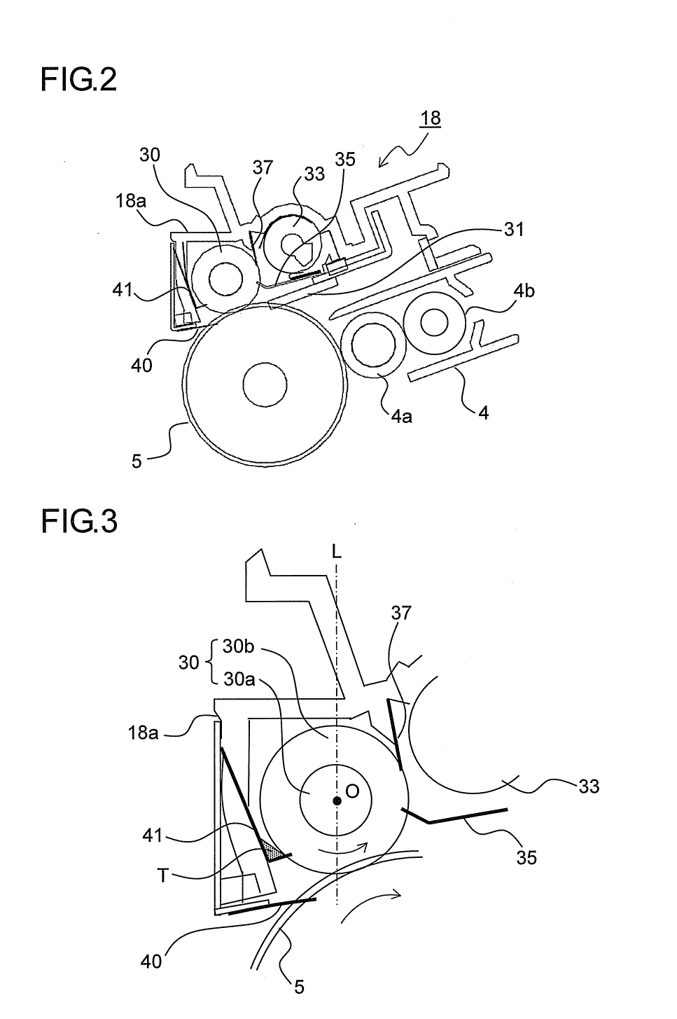

FIG. 2 is a side sectional view showing the charging device 4, the photosensitive drum 5, and a cleaning device 18 according to a first embodiment of the present disclosure, and FIG. 3 is a partial enlarged view showing a cleaning brush 30 of the cleaning device 18 shown in FIG. 2 and an area around the cleaning brush 30. The charging device 4 includes a charging roller 4a that contacts an outer circumferential surface of the photosensitive drum 5 and applies a charge bias to the photosensitive drum 5, and a charge cleaning roller 4b for cleaning the charging roller 4a.

The photosensitive drum 5 is an amorphous silicon (a-Si) photosensitive member in which, for example, an amorphous silicon (a-Si) photo conductive layer is formed as a photosensitive layer on an outer circumferential surface of a conductive base drum of aluminum. On an upper surface of the photosensitive layer, there is laid a surface protection layer formed of an a-Si inorganic insulator or semiconductor based on, for example, SiC, SiN, SiO, SiON, or SiCN.

The cleaning device 18 includes a housing 18a that has an opening formed in a face thereof facing the photosensitive drum 5, and inside the housing 18a, a cleaning brush 30, a cleaning blade 31, and a collection screw 33 are disposed. As a pretreatment, the cleaning brush 30 fluffs up residual toner remaining on the photosensitive drum 5 after the toner image is transferred onto the sheet so that the residual toner can be effectively scraped off by the cleaning blade 31. The cleaning brush 30 is formed with a rotation shaft 30a arranged parallel to a rotation shaft of the photosensitive drum 5 and a large number of brush fibers 30b radially standing on a circumferential surface of the rotation shaft 30a to form a brush shape. The cleaning brush 30 is made to rotate by an unillustrated drive means in the same direction as the photosensitive drum 5 as seen at a contact surface where the cleaning brush 30 and the photosensitive drum 5 contact each other, that is, the cleaning brush 30 rotates in the counterclockwise direction so as to send the toner downstream in the rotation direction of the photosensitive drum 5 (that is, the clockwise direction) where the collection screw 33 is disposed. An overlapping amount (a biting amount) of the cleaning brush 30 with respect to the photosensitive drum 5 is 0.2 mm-1.2 mm.

At the surface of the photosensitive drum 5, at a position downstream of the contact surface where the photosensitive drum 5 and the cleaning brush 30 contact each other with respect to the rotation direction of the photosensitive drum 5 (right side in FIG. 2), the cleaning blade 31 is disposed to scrape off the residual toner fluffed up by the cleaning brush 30 from the surface of the photosensitive drum 5. The cleaning blade 31 is fixed such that one edge portion thereof contacts the outer circumferential surface of the photosensitive drum 5 substantially all along a width direction of the photosensitive drum 5, and such that the cleaning blade 31 is inclined upward than a horizontal direction toward the other edge portion of the cleaning blade 31. As the cleaning blade 31, for example, a polyurethane-rubber blade having a JIS hardness of 78° is used. The cleaning blade 31 is attached to contact the photosensitive drum 5 at a predetermined angle with respect to a tangential direction of the photosensitive drum 5. Note that the material and the hardness of the cleaning blade 31, the size of the cleaning blade 31, the biting amount of the cleaning blade 31 with respect to the photosensitive drum 5, pressure with which the cleaning blade 31 is pressed against the photosensitive drum 5, etc. are properly set according to specifications of the photosensitive drum 5.

The residual toner removed from the surface of the photosensitive drum 5 by the cleaning brush 30 and the cleaning blade 31 is discharged to outside the cleaning device 18 along with rotation of the collection screw 33, and the discharged residual toner is then conveyed to be stored in a toner collection container (not shown).

At a surface of the cleaning brush 30, a flicker 35 is disposed downstream (right side in FIG. 2) of the contact surface where the cleaning brush 30 and the photosensitive drum 5 contact each other in the rotation direction of the photosensitive drum 5. The flicker 35 is a plate member disposed in contact with tips of the brush fibers 30b of the cleaning brush 30 for shaking off the toner adhered to the brush fibers 30b after the cleaning brush 30 fluffs up the toner on the surface of the photosensitive drum 5. When the rotation shaft 30a of the cleaning brush 30 rotates and the contact state between the tips of the brush fibers 30b and the flicker 35 is released, the brush fibers 30b once bent by contacting the flicker 35 stand up in a flash due to restorability of the brush fibers 30b. At this moment, the toner adhered to the brush fibers 30b is flicked to fly. An overlapping amount (a biting amount) of the flicker 35 with respect to the brush fibers 30b is 0.1 mm-1.1 mm.

Between the cleaning brush 30 and the collection screw 33, a partition member 37 is disposed. The partition member 37 divides an interior of the housing 18a into a toner collection path for the collection screw 33 to collect toner and a rotation space for the cleaning brush 30. This helps prevent the toner scraped off by the cleaning blade 31 and the toner fluffed up by the cleaning brush 30 from flowing back into the rotation space for the cleaning brush 30 and from adhering to the cleaning brush 30 again.

As described above, with the flicker 35 disposed in contact with the brush fibers 30b of the cleaning brush 30, it is possible to effectively shake off the toner adhered to the brush fibers 30b of the cleaning brush 30. Further, with the partition member 37 disposed to separate the toner collection path for the collection screw 33 to collect toner and the rotation space for the cleaning brush 30 from each other, it is possible to effectively reduce backflow of the toner into the rotation space for the cleaning brush 30 after the toner is shaken off from the brush fibers 30b to fly, and thus to prevent re-adhesion of the toner to the brush fibers 30b. This makes it possible to reduce clogging of the cleaning brush 30, and thus to fully clean the surface of the photosensitive drum 5 so that high-quality image formation can be performed.

Note that the partition member 37 is preferably disposed, in a range where the effect of the provision of the partition member 37 is effective, in the vicinity of a position of the brush fibers 30b when the contact state between the brush fibers 30 and the flicker 35 is released and the shape of the brush fibers 30 is restored, and that the partition member 37 can be disposed in a manner suitable to the material of the brush fibers 30b, the level of engagement between the brush fibers 30b and the flicker 35, etc. If the partition member 37 is in a slight contact with the brush fibers 30b, backflow of the toner to the rotation space for the cleaning brush 30 and re-adhesion of the toner to the cleaning brush 30 along therewith can be reduced more effectively. Note, however, that the partition member 37 may be disposed in the vicinity of, and out of contact with, the brush fibers 30b, taking durability of the cleaning brush 30 into consideration.

To an upstream-side edge (a left edge in FIG. 2) of the opening formed in the housing 18a with respect to the rotation direction of the photosensitive drum 5, a seal member 40 is attached. One edge portion (a left edge in FIG. 3) of the seal member 40 is fixed to the housing 18a to form a stationary edge of the seal member 40. On the other hand, the other edge portion (a right edge in FIG. 3) of the seal member 40 forms a free edge of the seal member 40, and contacts the outer circumferential surface of the photosensitive drum 5. The seal member 40 is preferably a soft and flexible member so that the seal member 40 does not damage the photosensitive layer formed on the outer circumferential surface of the photosensitive drum 5. As the seal member 40, a 100 μm-thick urethane sheet is used, for example, but a thin sheet other than a urethane sheet may be used.

Above the seal member 40, a protection member 41 is disposed. The protection member 41 is a sheet member one edge portion thereof is bent such that the protection member 41 has an L-shape in section. A portion of the protection member 41 along a longitudinal direction of the L-shape is fixed to the housing 18a, and the bent edge portion contacts the outer circumferential surface of the cleaning brush 30 (the brush fibers 30b) substantially all along a longitudinal direction of the cleaning brush 30 (a direction perpendicular to the sheet surface of FIG. 3).

A material of the protection member 41 is metal such as SUS or PET resin, and the protection member 41 is 0.05 mm-0.2 mm thick. An overlapping amount (a biting amount) of the protection member 41 with respect to the brush fibers 30b is 0.05 mm-1.0 mm. A location of the protection member 41 is not limited to directly above the seal member 40, and as long as the protection member 41 is located above the seal member 40, the protection member 41 may be disposed in another position upstream in the rotation direction of the photosensitive drum 5 with respect to a vertical line L passing a rotation center O of the cleaning brush 30 (in FIG. 3, the left side of the vertical line L).

According to the present embodiment, since the protection member 41 is disposed above the seal member 40 so as to cover the seal member 40, and the protection member 41 and the cleaning brush 30 contact each other, a structure is achieved where no gap exists between the protection member 41 and the cleaning brush 30. With this structure, toner T that has slipped by the partition member 37 accumulates on the protection member 41, and this helps reduce accumulation of toner on the seal member 40, eliminating possibility of excessive pressure contact of the seal member 40 with the surface of the photosensitive drum 5.

As a result, paper powder adhering to the surface of the photosensitive drum 5 can slip through a contact portion between the seal member 40 and the surface of the photosensitive drum 5, and thus no cluster of such paper powder is caused to stay at the contact portion, and accordingly uplift of the seal member 40 is not caused, either. Thus, it is possible to effectively reduce pollution of an interior of the image forming apparatus 100 caused by toner falling through a gap between the seal member 40 and the photosensitive drum 5.

Toner T accumulated on the protection member 41 adheres little by little to the brush fibers 30b of the cleaning brush 30, and is returned into the housing 18a by rotation of the cleaning brush 30. Toner T is then shaken off by the flicker 35 inside the housing 18a, to be collected by the collection screw 33. Part of toner T adhered to the brush fibers 30b also re-adheres to the outer circumferential surface of the photosensitive drum 5, and such part of toner T is scraped off by the cleaning blade 31.

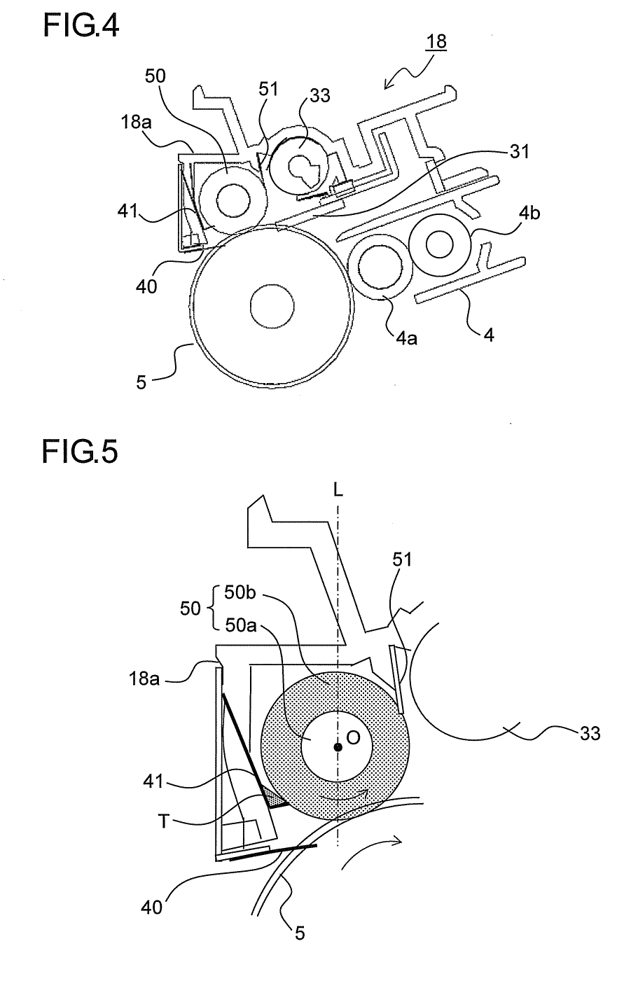

FIG. 4 is a side sectional view showing the charging device 4, the photosensitive drum 5, and a cleaning device 18 according to a second embodiment of the present disclosure, and FIG. 5 is a partial enlarged view showing a rubbing roller 50 of the cleaning device 18 shown in FIG. 4 and an area around the rubbing roller 50. In the present embodiment, the rubbing roller 50 is used instead of the cleaning brush 30 of the first embodiment. The rubbing roller 50 not only removes residual toner remaining on the surface of the photosensitive drum 5 but also rubs and polishes the photosensitive layer on the surface of the photosensitive drum 5 by using the residual toner.

Further, no flicker 35 of the first embodiment is provided in the present embodiment, but instead, a scraper 51 is provided for scraping off toner adhered to an outer circumferential surface of the rubbing roller 50. The scraper 51 is positioned in the same location as the partition member 37 in the cleaning device 18 of the first embodiment, and the scraper 51 also plays a part of a partition for dividing the interior of the housing 18a into a rotation space for the rubbing roller 50 and a toner collection path for the collection screw 33 to collect toner.

An example of the structure of the rubbing roller 50 is one where a foam layer of an EPDM rubber having an Asker C hardness of 55° is formed as a roller body 50b around a metal rotation shaft 50a. The material for the roller body 50b is not limited to the EPDM rubber, but the roller body 50b may be formed of a rubber of another material or a foamed rubber body, and a material having an Asker C hardness of in the range of 10°-90° is preferably used.

In the present embodiment as well, as in the first embodiment, the protection member 41 is disposed above the seal member 40 so as to cover the seal member 40, and also, the protection member 41 and the rubbing roller 50 contact each other, and in this structure, there is no gap between the protection member 41 and the rubbing roller 50. With this structure, toner T that has slipped by the scraper 51 accumulates on the protection member 41, and this helps reduce accumulation of toner on the seal member 40, eliminating possibility of excessive pressure contact of the seal member 40 with the surface of the photosensitive drum 5.

As a result, paper powder adhered to the surface of the photosensitive drum 5 can slip through a contact portion between the seal member 40 and the surface of the photosensitive drum 5, and thus no cluster of such paper powder is caused to stay at the contact portion, and accordingly uplift of the seal member 40 is not caused, either. Thus, it is possible to effectively reduce pollution of the interior of the image forming apparatus 100 caused by toner falling through a gap between the seal member 40 and the photosensitive drum 5. The material, the thickness, the location, etc. of the protection member 41 are the same as in the first embodiment, and thus descriptions thereof will be omitted, but it should be noted that a large overlapping amount (a large biting amount) of the protection member 41 with respect to the rubbing roller 50 causes a large frictional resistance, which invites deformation of the protection member 41 and an increase in rotational load of the rubbing roller 50. To prevent this, the overlapping amount (the biting amount) of the protection member 41 with respect to the rubbing roller 50 is preferably equal to or smaller than the lower limit of the overlapping amount in the first embodiment (that is, 0.05 mm or smaller).

Toner T accumulated on the protection member 41 adheres little by little to the rubbing roller 50, and is returned into the housing 18a by rotation of the rubbing roller 50. Toner T is then scraped off by the scraper 51 inside the housing 18a, and collected by the collection screw 33. Part of toner T adhered to the rubbing roller 50 also re-adheres to the outer circumferential surface of the photosensitive drum 5, and such part of toner T is scraped off by the cleaning blade 31.

It should be understood that the present disclosure is not limited to the above embodiments, and various modifications are possible within the scope of the present disclosure. For example, although the digital MFP as shown in the FIG. 1 has been dealt with as an example of the image forming apparatus 100 in the above embodiments, application of the present disclosure is not limited to digital MFPs, but the present disclosure is just equally applicable to other types of image forming apparatuses including a cleaning device, such as monochrome and color printers, color MFPs, and the like.

The present disclosure can be used in a cleaning device that removes residual toner remaining on a surface of an image carrier. By using the present disclosure, it is possible with a simple structure to provide a cleaning device that is capable of effectively reducing leakage of toner through a gap between a seal member and an image carrier, and an image forming apparatus including such a cleaning device.

What is claimed is:

1. A cleaning device, comprising:
a housing that is disposed above a cylindrical image carrier on an outer circumferential surface of which a toner image is carried, the housing having an opening formed in a face thereof facing the image carrier;
a cleaning member that is disposed in vicinity of the opening of the housing, and that removes residual toner adhered to the image carrier downstream of the image carrier in the rotation direction of the image carrier by rotating in contact with the outer circumferential surface of the image carrier in a direction same as a rotation direction of the image carrier as seen at a contact surface where the cleaning member and the image carrier contact each other;
a cleaning blade that contacts the outer circumferential surface of the image carrier at a position downstream of the cleaning member with respect to the rotation direction of the image carrier, and that removes residual toner adhered to the image carrier;
a collection member that collects waste toner inside the housing to convey the waste toner to outside the housing;
a seal member that is disposed at an upstream-side edge of the opening of the housing with respect to the rotation direction of the image carrier, and that prevents leakage of waste toner through a gap between the housing and the image carrier by contacting the outer circumferential surface of the image carrier at a position upstream of the cleaning member; and
a protection member that is disposed above the seal member with an interval therebetween, and that contacts the cleaning member.

2. The cleaning device of claim 1,
wherein
the protection member is disposed upstream in the rotation direction of the image carrier with respect to a vertical line passing a rotation center of the cleaning member.

3. The cleaning device of claim 1,
wherein
the protection member is a sheet member having a bent edge portion such that the protection member has an L-shape in section;
a portion of the protection member along a longitudinal direction of the L-shape is fixed to the housing; and
the bent edge portion contacts an outer circumferential surface of the cleaning member substantially all along a longitudinal direction of the cleaning member.

4. The cleaning device of claim 1,
wherein
the cleaning member is a cleaning brush including a rotation shaft and a large number of brush fibers radially standing on a circumferential surface of the rotation shaft.

5. The cleaning device of claim 4,
wherein
an overlapping amount of the protection member with respect to the brush fibers is 0.05 mm-1.0 mm.

6. The cleaning device of claim 4, further comprising a flicker that is disposed to contact tips of the brush fibers and shakes off toner adhered to the cleaning brush.

7. The cleaning device of claim 4,
wherein
a partition member is provided to divide an interior of the housing into a rotation space for the cleaning brush and a toner collection path for the collection member to collect toner.

8. The cleaning device of claim 1,
wherein
the cleaning member is a rubbing roller that removes residual toner remaining on the outer circumferential surface of the image carrier and also rubs and polishes the outer circumferential surface of the image carrier by using the residual toner.

9. The cleaning device of claim 8,
wherein
an overlapping amount of the protection member with respect to the rubbing roller is 0.05 mm or smaller.

10. The cleaning device of claim 8, further comprising a scraper that is disposed to divide an interior of the housing into a rotation space for the rubbing roller and a toner collection path for the collection member to collect toner, and that is disposed also to contact an outer circumference surface of the rubbing roller to scrape off toner adhered to the outer circumferential surface of the rubbing roller.

11. An image forming apparatus, comprising the cleaning device of claim 1.
